(19) United States
(12) Patent Application Publication
(10) Pub. No.: US 2002/0009570 A1
(43) Pub. Date: Jan. 24, 2002

(54) Floor mat

(76) Inventor: Jennifer L. Lauer, Wilmette, IL (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(21) Appl. No.: 09/860,875

(22) Filed: May 18, 2001

Related U.S. Application Data
(60) Provisional application No. 60/205,359, filed on May 18, 2000.

(51) Int. Cl. B32B 3/02

(52) U.S. Cl. 428/64.1; 428/14; 428/202

(57) ABSTRACT

A floor mat for protecting a floor surface beneath a baby's highchair, or other area prone to spillage, is substantially composed of a flexible, water impervious body of a sufficient overall thickness to be rollable for washing and storage. The floor mat can be comprised of a laminate of top and bottom transparent plastic layers with a central paper layer. The paper layer can carry a graphic decoration on one or both sides. The floor mat can alternately be composed of a single sheet having graphic decorations applied directly to one or both surfaces of the sheet.

This application claims the benefit of the earlier filing date of provisional application serial no. 60/205,359 filed May 18, 2000.

### TECHNICAL FIELD of the INVENTION

The present invention relates to floor mats. Particularly, the present invention relates to a floor mat which is used in association with an infant highchair to maintain a sanitary condition below the feeding area of the highchair.

### BACKGROUND of the INVENTION

When a baby reaches the age at which solid food is consumed, the baby is typically fed while seated in a highchair. Highchairs typically include a removable tray intended to support baby food in a bowl or plate, and the eating utensils.

Ideally, any spillage of the food from the bowl or plate or from the eating utensils is contained within the tray such as to keep the surrounding floor free of spillage.

In reality, the highchair tray is never large enough to prevent some spillage in the local area of the floor generally beneath the highchair. Depending on the age and temperament of the baby, spillage can be quite severe in this area. Additionally, food bowls and plates and eating utensils can be pushed off the tray or tossed a short distance by the baby.

Plastic, foldable floor mats are known for protecting the floor surrounding the highchair. However, such floor mats can be unwieldy to clean in the kitchen sink, and must be stored for convenience, in a folded condition, in a drawer, on a shelf, or other particularized location.

The present inventor has recognized that it would be desirable to provide a floor mat for a highchair which is easily cleaned, and easily deployed beneath a highchair, and then conveniently stored after use.

### SUMMARY of the INVENTION

The present invention provides a flexible floor mat for a highchair having a sufficient thickness to be rolled into a tubular configuration, the tubular configuration allowing the floor mat to be conveniently stored. The rolled floor mat can be stood vertically, facilitating compact storage. The present invention provides a floor mat which can be partially rolled into a trough shape to be easily washed and sprayed at a kitchen sink without creating overspray or splashing outside of the kitchen sink. The present invention provides a floor mat which has a small thickness but is sufficiently rigid to be manipulated by the user to slide the floor mat or retract the floor mat under the highchair, using a one hand gripping of the floor mat.

According to a preferred embodiment of the present invention, the floor mat is configured in a circular shape having a diameter of approximately four feet. The floor mat can be substantially composed of plastic. The plastic can carry or display decorations or other visual information, on one or both sides of the mat. Alternately, the floor mat can be a lamination of an inner layer of paper interposed between surface layers of plastic. The paper can have decorative images on one or both sides thereof. Particularly, the paper can be printed with four-color images and the plastic surface layers can be transparent.

The present invention floor mat can also be advantageously used beneath a child's chair or beneath an art table or easel, or anywhere that a floor protecting device is needed.

Numerous other advantages and features of the present invention will become readily apparent from the following detailed description of the invention and the embodiments thereof, from the claims and from the accompanying drawings.

### BRIEF DESCRIPTION of the DRAWINGS

FIG. 1 is a plan view of a highchair floor mat in accordance with the invention;

FIG. 2 is a sectional view taken generally along line 2-2 of FIG. 1;

FIG. 3 is a perspective view of the floor mat as shown in FIG. 1, but rolled into a tubular configuration for storage;

FIG. 4 is a front view of an alternate floor mat rolled into a tubular configuration and stood vertical for storage; and

FIG. 5 is a perspective view of the floor mat of FIG. 1 shown rolled and partially inserted into a sink for cleaning.

### DETAILED DESCRIPTION of the PREFERED EMBODIMENT

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

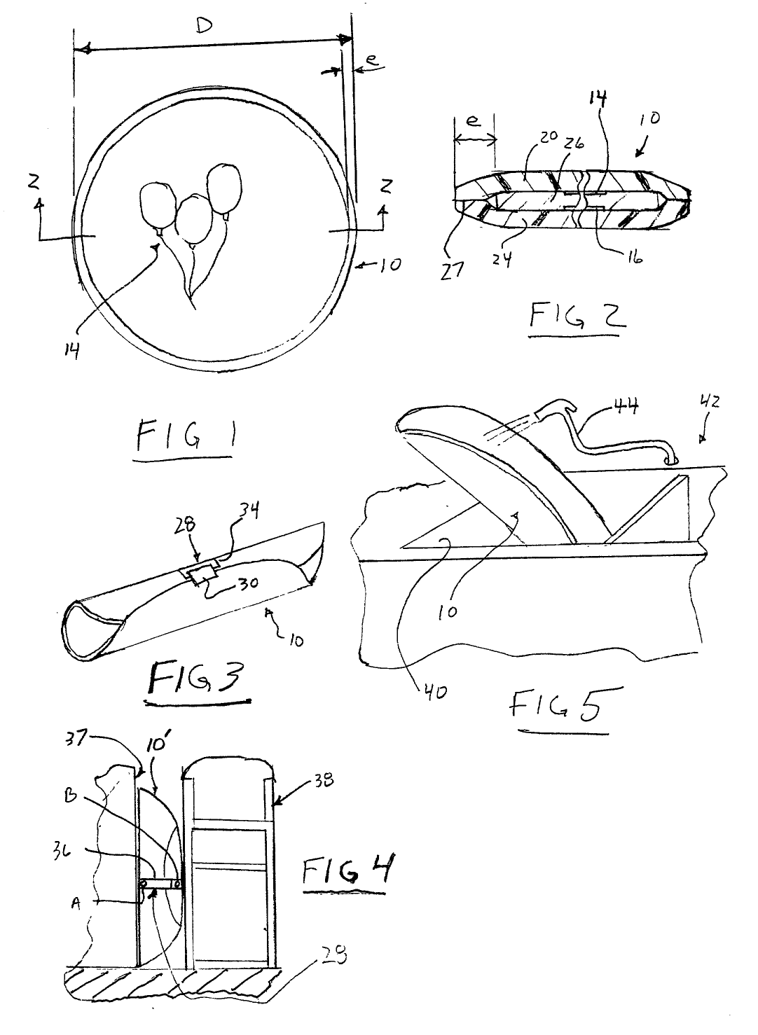

FIG. 1 illustrates a floor mat 10 of the present invention. The floor mat 10 is illustrated as being circular in shape with a diameter D. Preferably the diameter D is approximately four feet, although other diameters are encompassed by the present invention. Additionally, although a circular floor mat 10 is shown, other shapes such as square, elliptical, polygonal, etc. are encompassed by the invention. The floor mat 10 includes a decorative display 14 on the front surface thereof, and can also include a decorative display 16 on a rear surface thereof, both displays shown schematically in FIG. 2.

FIG. 2 illustrates in cross section that the floor mat 10 includes a top layer 20, composed of a water impervious material, such as plastic, and a bottom layer 24 which can also be composed of a water impervious material, such as plastic. The top layer 20 and the bottom layer 24 cover top and bottom surfaces of a center sheet of paper 26 which carries or displays the decorative displays 14, 16. The displays can be four-color printed graphics. The three layers 20, 24 and 26 are preferably heat laminated together, with the top and bottom layers 20, 24 extending outside the central layer 26 by the dimension e and sealed together at a seal 27 within the dimension e. The dimension e is preferably about 1/4inch.

The preferred materials for the layers 20, 24 is polyester, although other plastic materials, being water impervious for ease of cleaning, could be used as well. Each layer 20, 24 can be within a thickness range of about 1 to 3 mils, preferably about 1.7 to 2 mils. The central layer 26 is preferably 80lb glossy paper which is suitable for carrying or displaying the decorative displays 14, 16.

Although a laminate is illustrated in FIG. 2, it is encompassed by the present invention that the floor mat is composed of a single thickness of one material such as a single sheet of plastic material. In this regard, a single sheet of styrene having water impervious surfaces can be used. The opposite surfaces of the styrene sheet can carry or display decorative displays.

Additionally, although a water impervious plastic material is described for both the top and bottom layers 20, 24, or opposite surfaces, it is encompassed by the invention that the top layer 20, or top surface, is a water impervious layer to allow spillage to be wiped therefrom, while the bottom layer 24, or bottom surface, is not necessarily water impervious. Advantageously, however, the top and bottom layers 20, 24, or top and bottom surfaces, are both impervious so that the floor mat 10 can be reversible for selective use beneath the high chair.

FIG. 3 illustrates the floor mat 10 in a rolled condition suitable for storage.

The mat 10 has been rolled into a tubular form and releasably fastened onto itself using a retaining mechanism 28. The retaining mechanism could be a separate device, such as an encircling device, such as a rubber band, a strap, a tie, etc. Advantageously, the retaining mechanism can be incorporated as an attached or unitary part of the floor mat. In this regard, a first tab 30 could be attached to an edge of the floor mat and a second tab 34 could be attached to another position on the floor mat, the other position depending on how tightly it is desired to roll the floor mat. The tabs 30, 34 could carry thereon hook and loop fastening surfaces (VELCRO) to releasably hold the mat 10 in its rolled condition. Alternatively, the tabs 30, 34 could include coacting buttons, or pressure sensitive adhesive, or snaps, or other means of releasably holding the mat 10 in a tubular, rolled form.

FIG. 4 illustrates an alternate floor mat 10'rolled for storage and stood vertically. The alternate floor mat is identical to the previously described floor mat 10, except that the fastening mechanism 28 is an encircling device. Particularly, a strap 36 is connected to one surface of the floor mat at a point A, wrapped around the rolled mat, and fastened to itself at the point B, by coacting hook and loop fasteners, or snaps, or buttons, or pressure adhesive tape, etc. The mat 1O'is shown stored between a wall 37 and a highchair 38.

FIG. 5 illustrates the mat 10 partially rolled to fit within the confines of a basin 40 of a sink 42. The sink 42 typically include a spray hose 44 for rinsing dishes. By rolling the mat 10 into a trough shape, it can be easily cleaned and rinsed within the confines of the sink 40 by the spray washer 44, without excessive overspray or spillage outside of the basin 40.

Although preferred embodiment floor mats 10, 10'are described above having a laminated structure of certain layer thicknesses, the invention encompasses a floor mat having only a single material thickness as well. The thickness of the floor mat should be sufficient such that the floor mat can be rolled into a tubular form that can be stood for storage. Preferably, the floor mat is sufficiently rigid in that it can be slid under a high chair by pushing along the floor without bunching or buckling. The rolled form of the floor mat is sufficiently rigid to resist buckling when held at one end and cantilevered horizontally.

From the foregoing, it will be observed that numerous variations and modifications may be effected without departing from the spirit and scope of the invention. It is to be understood that no limitation with respect to the specific embodiments illustrated herein is intended or should be inferred. It is, of course, intended to cover by the appended claims all such modifications as fall within the scope of the claims.

The invention claimed is:

1. A floor mat, comprising:
a body being substantially flat and including at least a top surface sheet that is water impervious, said body being sufficiently rigid to be manually rolled about an axis and fully supportable on a bottom edge thereof standing vertically.

2. The floor mat according to claim 1, wherein said body comprises a bottom surface layer that is water impervious.

3. The floor mat according to claim 2 comprising a paper layer interposed between said top surface sheet and said bottom surface layer.

4. The floor mat according to claim 1, wherein said top surface sheet is composed of plastic.

5. The floor mat according to claim 4, wherein said top surface sheet comprises a thickness of about 1 to 3 mils.

6. The floor mat according to claim 3, wherein said paper carries a decorative display beneath said top surface sheet, said top surface sheet being transparent.

7. The floor mat according to claim 1, wherein said floor mat includes a circular outer perimeter.

8. The floor mat according to claim 1, wherein said body comprises a laminate structure including top and bottom layers of a plastic material, and a center layer of a paper material, said top and bottom layers being together about 3.4 mils thick.

9. The floor mat according to claim 8, wherein each of said plastic layers are about 1.7 mils thick and said paper layer is 80lb paper.

10. The floor mat according to claim 1, wherein said body comprises a circular shape having a diameter of approximately 4 feet.

11. The floor mat according to claim 1, further comprising a retaining mechanism attached to said body and at least partially encircling a portion of said body when in said rolled form to hold said body in said rolled form for storage.

12. The floor mat according to claim 1, wherein said body comprises only a single sheet, defining an overall thickness of said body.
